(19) United States
(12) Patent Application Publication
(10) Pub. No.: US 2024/0294420 A1
(43) Pub. Date: Sep. 5, 2024

(54) STUFFED a-QUARTZ AND GAHNITE GLASS-CERAMIC ARTICLES HAVING IMPROVED MECHANICAL DURABILITY

(71) Applicant: CORNING INCORPORATED, CORNING, NY (US)

(72) Inventors: George Halsey Beall, Big Flats, NY (US); John Philip Finkeldey, Elkland, PA (US); Charlene Marie Smith, Corning, NY (US)

(21) Appl. No.: 18/591,172

(22) Filed: Feb. 29, 2024

Related U.S. Application Data
(60) Provisional application No. 63/449,498, filed on Mar. 2, 2023.

(51) Int. Cl. C03C 10/00; C03B 32/02; C03C 3/085

(52) U.S. Cl. CPC C03C 10/0009; C03B 32/02; C03C 3/085; C03C 2204/00

(57) ABSTRACT

A glass-ceramic article includes a crystalline phase comprising stuffed α-quartz and gahnite and a residual glass phase. The glass-ceramic has a composition comprising: greater than or equal to 69.5 mol % and less than or equal to 85 mol % SiO₂; greater than or equal to 7 mol % and less than or equal to 20 mol % Al₂O₃; greater than or equal to 4.5 mol % and less than or equal to 12 mol % ZnO: greater than or equal to 1 mol % and less than or equal to 8 mol % LizO; and greater than or equal to 0.5 mol % and less than or equal to 4 mol % ZrO₂.

This application claims the benefit of priority of U.S. Provisional Application Ser. No. 63/449,498 filed on Mar. 2, 2023, the content of which is relied upon and incorporated herein by reference in its entirety.

### FIELD

The present specification relates to glass compositions and, in particular, to ion-exchangeable glass-ceramic articles having stuffed α-quartz and gahnite.

### TECHNICAL BACKGROUND

Glass articles, such as cover glasses, glass backplanes, and the like, are employed in both consumer and commercial electronic devices such as LCD and LED displays, computer monitors, automated teller machines (ATMs), and the like. Some of these glass articles may include “touch” functionality which necessitates that the glass article be contacted by various objects including a user's fingers and/or stylus devices and, as such, the glass must be sufficiently robust to endure regular contact without damage, such a scratching. Indeed, scratches introduced into the surface of the glass article may reduce the strength of the glass article as the scratches may serve as initiation points for cracks leading to catastrophic failure of the glass.

Accordingly, a need exists for alternative materials to glass which have improved mechanical properties relative to glass.

### SUMMARY

According to a first aspect A1, a glass-ceramic article may include: a crystalline phase comprising stuffed α-quartz and gahnite; and a residual glass phase, the glass-ceramic article having a composition comprising: greater than or equal to 69.5 mol % and less than or equal to 85 mol % SiO₂; greater than or equal to 7 mol % and less than or equal to 20 mol % Al₂O₃; greater than or equal to 4.5 mol % and less than or equal to 12 mol % ZnO; greater than or equal to 1 mol % and less than or equal to 8 mol % Li₂O; and greater than or equal to 0.5 mol % and less than or equal to 4 mol % ZrO₂.

A second aspect A2 includes the glass-ceramic article according to the first aspect A1, wherein a total amount of stuffed α-quartz is greater than or equal to 60 wt %, based on a total weight of the crystalline phase.

A third aspect A3 includes the glass-ceramic article according to the first aspect A1 or the second aspect A2, wherein the glass-ceramic article comprises greater than or equal to 70 mol % and less than or equal to 83 mol % SiO₂.

A fourth aspect A4 includes the glass-ceramic article according to the third aspect A3, wherein the glass-ceramic article comprises greater than or equal to 71 mol % and less than or equal to 81 mol % SiO₂.

A fifth aspect A5 includes the glass-ceramic article according to any one of the first through fourth aspects A1-A4, wherein the glass-ceramic article comprises greater than or equal to 5 mol % and less than or equal to 11 mol % ZnO.

A sixth aspect A6 includes the glass-ceramic article according to any one of the first through fifth aspects A1-A5, wherein the glass-ceramic article comprises greater than or equal to 1.5 mol % and less than or equal to 7 mol % Li₂O.

A seventh aspect A7 includes the glass-ceramic article according to any one of the first through sixth aspects A1-A6, wherein the glass-ceramic article comprises greater than or equal to 0.75 mol % and less than or equal to 3.5 mol % ZrO₂.

An eighth aspect A8 includes the glass-ceramic article according to any one of the first through seventh aspects A1-A7, wherein the glass-ceramic article comprises comprising greater than 0 mol % and less than or equal to 1 mol % SnO₂.

A ninth aspect A9 includes the glass-ceramic article according to any one of the first through eighth aspects A1-A8, wherein the crystalline phase further comprises β-quartz, zirconia, mullite, or a combination thereof.

A tenth aspect A10 includes the glass-ceramic article according to any one of the first through ninth aspects A1-A9, wherein Al₂O₃/(ZnO+Li₂O) is greater than or equal to 1.00 and less than or equal to 1.45.

An eleventh aspect A11 includes the glass-ceramic article according to any one of the first through tenth aspects A1-A10, wherein a Mohs hardness of the glass-ceramic article is greater than or equal to 7.

A twelfth aspect A12 includes the glass-ceramic article according to any one of the first through eleventh aspects A1-A11, wherein the Vickers hardness of the glass-ceramic article may be greater than or equal to 800 kgf/mm.

A thirteenth aspect A13 includes the glass-ceramic article according to any one of the first through twelfth aspects A1-A12, wherein a Poisson's ratio of the glass-ceramic article is greater than or equal to 0.085 and less than or equal to 0.11.

A fourteenth aspect A14 includes the glass-ceramic article according to any one of the first through thirteenth aspects A1-A13, wherein an average transmittance of the glass-ceramic article is greater than or equal to 0% and less than 20%over the wavelength range of 400 nm to 800 nm as measured at an article thickness of 0.8 mm.

A fifteenth aspect A14 includes the glass-ceramic article according to any one of the first through thirteenth aspects A1-A13, wherein an average transmittance of the glass-ceramic article is greater than or equal to 20% over the wavelength range of 400 nm to 800 nm as measured at an article thickness of 0.8 mm.

A sixteenth aspect A16 includes the glass-ceramic article according to the fifteenth aspect A15, wherein the average transmittance of the glass-ceramic article is greater than or equal to 50% over the wavelength range of 400 nm to 800 nm as measured at an article thickness of 0.8 mm.

A seventeenth aspect A17 includes the glass-ceramic article according to the sixteenth aspect A16, wherein the average transmittance of the glass-ceramic article is greater than or equal to 85% over the wavelength range of 400 nm to 800 nm as measured at an article thickness of 0.8 mm.

According to an eighteenth aspect A18, a glass composition may include: greater than or equal to 69.5 mol % and less than or equal to 85 mol % SiO₂; greater than or equal to 7 mol % and less than or equal to 20 mol % Al₂O₃; greater than or equal to 4.5 mol % and less than or equal to 12 mol % ZnO; greater than or equal to 1 mol % and less than or equal to 8 mol % Li₂O; and greater than or equal to 0.5 mol % and less than or equal to 4 mol % ZrO₂, wherein Al₂O₃/(ZnO+Li₂O) is greater than or equal to 1.00 and less than or equal to 1.45.

A nineteenth aspect A19 includes the glass composition according to the eighteenth aspect A18, wherein Al₂O₃/(ZnO+Li₂O) is greater than or equal to 1.10 and less than or equal to 1.35.

A twentieth aspect A20 includes the glass composition according to the eighteenth aspect A18 or the nineteenth aspect A19, wherein the glass composition comprises greater than or equal to 70 mol % and less than or equal to 83 mol % SiO₂.

A twenty-first aspect A21 includes the glass composition according to the twentieth aspect A20, wherein the glass composition comprises greater than or equal to 71 mol % and less than or equal to 81 mol % SiO₂.

A twenty-second aspect A22 includes the glass composition according to any one of the eighteenth through twenty-first aspects A18-A21, wherein the glass composition comprises greater than or equal to 5 mol % and less than or equal to 11 mol % ZnO.

A twenty-third aspect A23 includes the glass composition according to any one of the eighteenth through twenty-second aspects A18-A22, wherein the glass composition comprises greater than or equal to 1.5 mol % and less than or equal to 7 mol % Li₂O.

A twenty-fourth aspect A24 includes the glass composition according to any one of the eighteenth through twenty-third aspects A18-A23, wherein the glass composition comprises greater than or equal to 0.75 mol % and less than or equal to 3.5 mol % ZrO₂.

A twenty-fifth aspect A25 includes the glass composition according to any one of the eighteenth through twenty-fourth aspects A18-A24, wherein the glass composition comprises greater than 0 mol % and less than or equal to 1 mol % SnO₂.

According to a twenty-sixth aspect A26, a method of forming a glass-ceramic article may include: heating a precursor glass article in an oven at a rate greater than or equal to 1° C./min and less than or equal to 10° C./min to a nucleation temperature, wherein the precursor glass article comprises a glass composition comprising: greater than or equal to 67 mol % and less than or equal to 85 mol % SiO₂; greater than or equal to 7 mol % and less than or equal to 20 mol % Al₂O₃; greater than or equal to 4.5 mol % and less than or equal to 12 mol % ZnO; greater than or equal to 1 mol % and less than or equal to 8 mol % Li₂O; and greater than or equal to 0.5 mol % and less than or equal to 4 mol % ZrO₂, wherein Al₂O₃/(ZnO+Li₂O) is greater than or equal to 1.00 and less than or equal to 1.45; maintaining the precursor glass article at the nucleation temperature in the oven for time greater than or equal to 0.1 hour and less than or equal to 8 hours to produce a nucleated crystallizable glass article; heating the nucleated crystallizable glass article in the oven at a rate greater than or equal to 1° C./min and less than or equal to 10° C./min to a crystallization temperature; maintaining the nucleated crystallizable glass article at the crystallization temperature in the oven for a time greater than or equal to 0.25 hour and less than or equal to 4 hours to produce the glass-ceramic article, wherein the glass-ceramic article comprises a crystalline phase and a residual glass phase; and cooling the glass-ceramic article to room temperature.

A twenty-seventh aspect A27 includes the method according to the twenty-sixth aspect A26, wherein the crystallization temperature is greater than or equal to 950° C.

A twenty-eighth aspect A28 includes the method according to the twenty-sixth aspect A26 or the twenty-seventh aspect A27, wherein the crystalline phase comprises greater than or equal to 60 wt % stuffed α-quartz, based on a total weight of the crystalline phase.

A twenty-ninth aspect A29 includes the method according to any one of the twenty-sixth through twenty-eighth aspects A26-A28, further comprising strengthening the glass-ceramic article in an ion exchange bath at a temperature greater than or equal to 350° C. to less than or equal to 550° C. for a time period greater than or equal to 2 hours to less than or equal to 12 hours to form an ion exchanged glass-ceramic article.

A thirtieth aspect A30 includes the method according to the twenty-ninth aspect A29, wherein the ion exchange bath comprises KNO₃.

A thirty-first aspect A31 includes the method according to the twenty-ninth aspect A29 or the thirtieth aspect A30, wherein the ion exchange bath comprises NaNO₃.

A thirty-second aspect A32 includes the method according to any one of the twenty-ninth through thirty-first aspects A29-A31, wherein the glass-ceramic article comprises a peak surface compressive stress greater than or equal to 80 MPa.

A thirty-third aspect A33 includes the method according to any one of the twenty-ninth through thirty-second aspects A29-A32, wherein the glass-ceramic article comprises a depth of compression 10 μm or greater.

A thirty-fourth aspect A34 includes the method according to any one of the twenty-ninth through thirty-third aspects A29-A33, wherein the glass-ceramic article has a thickness “t” and comprises a depth of compression greater than or equal to 0.05 t.

A thirty-fifth aspect A35 includes the method according to any one of the twenty-sixth through thirty-fourth aspects A26-A34, wherein a Mohs hardness of the glass-ceramic article is greater than or equal to 7.

A thirty-sixth aspect A36 includes the method according to any one of the twenty-sixth through thirty-fifth aspects A26-A35, wherein a Vickers hardness of the glass-ceramic article may be greater than or equal to 800 kgf/mm.

A thirty-seventh aspect A37 includes the method according to any one of the twenty-sixth through thirty-sixth aspects A26-A36, wherein a Poisson's ratio of the glass-ceramic article is greater than or equal to 0.085 and less than or equal to 0.11.

A thirty-eighth aspect A38 includes a consumer electronic device, comprising: a housing having a front surface, a back surface, and side surfaces; electrical components provided at least partially within the housing, the electrical components including at least a controller, a memory, and a display, the display being provided at or adjacent the front surface of the housing; and the glass-ceramic article according to any one of the first through seventeenth aspects A1-A17, at least one of disposed over the display and forming a portion of the housing.

Additional features and advantages of the glass-ceramic articles described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a plan view of an electronic device incorporating a glass-ceramic article, according to one or more embodiments described herein;

FIG. 2 is a perspective view of the electronic device of FIG. 1;

FIG. 3 is a photograph of a polished, transparent glass-ceramic article, according to one or more embodiments described herein;

FIG. 4 is a transmittance plot (i.e., x-axis: wavelength (in nm); y-axis transmittance (in %) of ion exchanged glass-ceramic articles, according to one or more embodiments described herein;

FIG. 5 is an X-ray diffraction (XRD) spectrum of a glass-ceramic article, according to one or more embodiments described herein;

FIG. 6 is an XRD spectrum of a glass-ceramic article, according to one or more embodiments described herein;

FIG. 7 is XRD spectra of a comparative glass-ceramic article and example glass-ceramic articles, according to one or more embodiments described herein

FIG. 8 is a plot of temperature (i.e., x-axis: temperature (° C)) versus contraction (i.e., y-axis ΔL/L (in ppm)) of example glass-ceramic articles, according to one or more embodiments described herein;

FIG. 9 is a plot of the concentration of SiO₂—LiAlO₂ solid solution (i.e., x-axis: SiO₂—LiAlO₂ solid solution (in mol %)) versus contraction (i.e., y-axis: ΔL/L (in ppm)) of example glass-ceramic articles, according to one or more embodiments described herein; herein;

FIG. 10 is a plot of depth (i.e., x-axis: depth (in mm)) versus stress (i.e., y-axis: stress (in MPa) of an ion exchanges example glass-ceramic article, according to one or more embodiments described herein;

FIG. 11 is a scanning electron microscopy (SEM) image of a glass-ceramic article, according to one or more embodiments described herein; and

FIG. 12 is an SEM image of a glass-ceramic article, according to one or more embodiments described herein.

### DETAILED DESCRIPTION

Reference will now be made in detail to various embodiments of glass compositions and glass-ceramic articles having improved mechanical durability formed therefrom. According to embodiments, a glass-ceramic article includes a crystalline phase comprising stuffed α-quartz and gahnite and a residual glass phase. The glass-ceramic may have a composition comprising: greater than or equal to 69.5 mol % and less than or equal to 85 mol % SiO₂; greater than or equal to 7 mol % and less than or equal to 20 mol % Al₂O₃; greater than or equal to 4.5 mol % and less than or equal to 12 mol % ZnO: greater than or equal to 1 mol % and less than or equal to 8 mol % Li₂O; and greater than or equal to 0.5 mol % and less than or equal to 4 mol % ZrO₂. Various embodiments of glass-ceramic articles and methods of making glass-ceramic articles will be referred to herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the glass compositions and resultant glass-ceramic articles described herein, the concentrations of constituent components (e.g., SiO₂, Al₂O₃, and the like) are specified in mole percent (mol %) on an oxide basis, unless otherwise specified.

The term “substantially free,” when used to describe the concentration and/or absence of a particular constituent component in a glass composition and the resultant glass-ceramic article, means that the constituent component is not intentionally added to the glass composition and the glass-ceramic article. However, the glass composition and the resultant glass-ceramic article may contain traces of the constituent component as a contaminant or tramp in amounts of less than 0.1 weight percent (wt %). As noted herein, the remainder of the application specifies the concentrations of constitutent component in mol %. The contaminant or tramp amounts of the constituent components are listed in wt % for manufacturing purposes and one skilled in the art would understand the contaminant and tramp amounts being listed in wt %.

The terms “0 mol %” and “free,” when used to describe the concentration and/or absence of a particular constituent component in a glass composition and the resultant glass-ceramic article, means that the constituent component is not present in the glass composition and the resultant glass-ceramic article.

The term “Mohs hardness,” as used herein, is measured using ASTM C1895-20.

The term, “Vickers hardness,” as used herein, is measured using ASTM E384-15.

The elastic modulus (also referred to as Young's modulus) of the glass-ceramic article, as described herein, is provided in units of gigapascals (GPa) and is measured in accordance with ASTM C623.

Shear modulus of the glass-ceramic article, as described herein, is provided in units of gigapascals (GPa). The shear modulus of the glass-ceramic article is measured in accordance with ASTM C623.

Poisson's ratio, as described herein is measured in accordance with ASTM C623.

Fracture toughness (K_{1C}) represents the ability of a glass composition to resist fracture. Fracture toughness is measured on a non-strengthened glass substrate, such as measuring the K_{1C} value prior to ion-exchange (IOX) treatment of the glass substrate, thereby representing a feature of a glass substrate prior to IOX. The fracture toughness test methods described herein are not suitable for glasses that have been exposed to IOX treatment. But, fracture toughness measurements performed as described herein on the same glass prior to IOX treatment (e.g., glass substrates) correlate to fracture toughness after IOX treatment, and are accordingly used as such. The chevron notched short bar (CNSB) method utilized to measure the K_{1C} value is disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*m is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). Unless otherwise specified, all fracture toughness values were measured by chevron notched short bar (CNSB) method.

The term “linear coefficient of thermal expansion” and “CTE,” as described herein, is measured in accordance with ASTM E228-85 over the given temperature and is expressed in terms of “x 10⁻⁷/° C.”

Transmittance data is measured using an open beam baseline and a Spectralon® reference reflectance disk. For total transmittance (Total Tx), the sample is fixed at the sphere entry point.

The term “average transmittance,” as used herein, refers to the average of transmittance measurements made within a given wavelength range.

The term “transparent,” when used to describe a glass-ceramic article herein, refers to an article that has an average transmittance of greater than or equal to 85% in a wavelength range from 400 nm to 800 nm at a thickness of 0.8 mm.

The term “transparent haze,” when used to describe a glass-ceramic article herein, refers to an article that has a transmittance in the range greater than or equal to 50% and less than 85% in a wavelength range from 400 nm to 800 nm at a thickness of 0.8 mm.

The term “translucent,” when used to describe a glass-ceramic article herein, refers to an article that has a transmittance in the range greater than or equal to 20% and less than 50% in a wavelength range from 400 nm to 800 nm at a thickness of 0.8 mm.

The term “opaque,” when used to describe a glass-ceramic article herein, refers to an article that has a transmittance in the range greater than or equal to 0% and less than 20% in a wavelength range from 400 nm to 800 nm at a thickness of 0.8 mm.

As used herein, “peak surface compressive stress” refers to the highest compressive stress (CS) value measured within a compressive stress region. In aspects, the peak compressive stress is located at the surface of the glass-ceramic article. In other aspects, the peak surface compressive stress may occur at a depth below the surface, giving the compressive stress profile the appearance of a “buried peak.” Unless specified otherwise, compressive stress (including surface CS) is measured by surface stress meter (FSM) using commercially available instruments, for example, the FSM-6000, manufactured by Orihara Industrial Co., Ltd. (Japan). Surface stress measurements rely upon the accurate measurement of the stress optical coefficient (SOC) which is related to the birefringence as a function of imposed compression of the glass-ceramic article. SOC in turn is measured according to Procedure C (Glass Disk Method) described in ASTM C770-16, entitled “Standard Test Method for measurement of Glass Stress-Optical Coefficient.” The maximum central tension (CT) values are measured using a Scattered Light Polariscope (SCALP), such as a SCALP-05 portable scattered light polariscope. The values reports for central tension (CT) herein refer to the maximum central tension, unless otherwise indicated.

According to the convention normally used in the art, compression or compressive stress (CS) is expressed as a negative (i.e., <0) stress and tension or tensile stress is expressed as a positive (i.e., >0) stress. Throughout this description, however, CS is expressed as a positive or absolute value (i.e., as recited herein, CS=|CS|).

As used herein, “depth of compression” (DOC) refers to the depth at which the stress within the glass-ceramic article changes from compressive to tensile. At the DOC, the stress crosses from a compressive stress to a tensile stress and thus exhibits a stress value of zero. Depth of compression may be measured using a Scattered Light Polariscope (SCALP), such as a SCALP-05 portable scattered light polariscope.

The phrase “glass composition,” as used herein, refers to a glass composition containing one or more nucleating agents which, upon thermal treatment, causes the nucleation of a crystal phase in the glass.

The phrase “precursor glass article,” as used herein, refers to an article made from a glass composition containing one or more nucleating agents which, upon thermal treatment, causes the nucleation of a crystal phase in the glass.

The phrase “glass-ceramic article,” as used herein, refers to an article formed from a glass composition following nucleation of the crystal phase in the glass composition.

Articles formed from glass-ceramics generally have improved mechanical properties relative to articles formed from glass due to the presence of crystalline grains, which may impede crack growth. However, it may also be desirable to form glass-ceramic articles having improved hardness and parabolic compressive stress profiles when ion exchanged.

Disclosed herein are glass compositions and glass-ceramic articles formed therefrom which mitigate the aforementioned problems. Specifically, the glass compositions described herein comprise a relatively high concentration of SiO₂ (e.g., greater than or equal to 67 mol % and less than or equal to 85 mol %) and a ratio of Al₂O₃/(ZnO+Li₂O) near unity (e.g., greater than or equal to 1.00 and less than or equal to 1.45) and may be subjected to certain heat treatments to form stuffed α-quartz and gahnite glass-ceramic articles. Upon heating the SiO₂—Al₂O₃—ZnO—Li₂O—ZrO₂ glass compositions described herein to a relatively high temperature (e.g., greater than or equal to 950° C.), a stuffed β-quartz phase is produced. Upon cooling, the β-quartz phase becomes partially de-stuffed with the exsolved ZnO and Al₂O₃ components combining to form gahnite (i.e., ZnAl₂O₄). The resulting quartz phase, still partially stuffed with Li, now includes a high enough concentration of SiO₂ to invert on cooling to ambient temperature to stuffed α-quartz. The Li-stuffed α-quartz maintains inter-atomic spacing (i.e., d-spacing) during cooling, and, along with gahnite, results in a relatively high hardness glass-ceramic article as compared to a β-quartzglass-ceramic article. The resulting glass-ceramic article may be ion-exchanged to achieve a desired depth of compression (e.g., greater than or equal to 0.05 t, where t is a thickness of the article).

The glass compositions and the resultant glass-ceramic articles described herein may generally be described as zinc-containing aluminosilicate glass compositions or glass-ceramic articles and comprise SiO₂, Al₂O₃, ZnO, and ZrO₂ as a nucleating agent. In addition to SiO₂, Al₂O₃, ZnO, and ZrO₂, the glass compositions and the resultant glass-ceramic articles described herein also contain Li₂O, to aid in forming the crystalline phase and to enable the ion-exchangeability of the glass-ceramic articles. The glass-ceramic articles described herein may include a crystalline phase comprising stuffed α-quartz and gahnite and a residual glass phase.

SiO₂ is the primary glass former in the glass compositions and the resultant glass-ceramic articles described herein and may function to stabilize the network structure of the glass-ceramic articles. The concentration of SiO₂ in the glass compositions and the resultant glass-ceramic should be sufficiently high (e.g., greater than or equal to 69.5 mol %) in order to form stuffed α-quartz when the glass composition is heat-treated to convert the glass composition to a glass-ceramic article. The amount of SiO₂ may be limited (e.g., to less than or equal to 85 mol %) to control the melting point of the glass composition, as the melting temperature of pure SiO₂ or high-SiO₂ glasses is undesirably high. Thus, limiting the concentration of SiO₂ may aid in improving the meltability and the formability of the glass composition and the resultant glass-ceramic article.

Accordingly, in embodiments, the glass composition and the resultant glass-ceramic article may comprise greater than or equal to 69.5 mol % and less than or equal to 85 mol % SiO₂. In embodiments, the glass composition and the resultant glass-ceramic article may comprise greater than or equal to 70 mol % and less than or equal to 83 mol % SiO₂. In embodiments, the glass composition and the resultant glass-ceramic article may comprise greater than or equal to 71 mol % and less than or equal to 81 mol % SiO₂. In embodiments, the concentration of SiO₂ in the glass composition and the resultant glass-ceramic article may be greater than or equal to 69.5 mol %, greater than or equal to 70 mol %, greater than or equal to 71 mol %, greater than or equal to 72 mol %, or even greater than or equal to 73 mol %. In embodiments, the concentration of SiO₂ in the glass composition and the resultant glass-ceramic article may be less than or equal to 85 mol %, less than or equal to 83 mol %, less than or equal to 81 mol %, or even less than or equal to 79 mol %. In embodiments, the concentration of SiO₂ in the glass composition and the resultant glass-ceramic article may be greater than or equal to 69.5 mol % and less than or equal to 85 mol %, greater than or equal to 69.5 mol % and less than or equal to 83 mol %, greater than or equal to 69.5 mol % and less than or equal to 81 mol %, greater than or equal to 69.5 mol % and less than or equal to 79 mol %, greater than or equal to 70 mol % and less than or equal to 85 mol %, greater than or equal to 70 mol % and less than or equal to 83 mol %, greater than or equal to 70 mol % and less than or equal to 81 mol %, greater than or equal to 70 mol % and less than or equal to 79 mol %, greater than or equal to 71 mol % and less than or equal to 85 mol %, greater than or equal to 71 mol % and less than or equal to 83 mol %, greater than or equal to 71 mol % and less than or equal to 81 mol %, greater than or equal to 71 mol % and less than or equal to 79 mol %, greater than or equal to 72 mol % and less than or equal to 85 mol %, greater than or equal to 72 mol % and less than or equal to 83 mol %, greater than or equal to 72 mol % and less than or equal to 81 mol %, greater than or equal to 72 mol % and less than or equal to 79 mol %, greater than or equal to 73 mol % and less than or equal to 85 mol %, greater than or equal to 73 mol % and less than or equal to 83 mol %, greater than or equal to 73 mol % and less than or equal to 81 mol %, or even greater than or equal to 73 mol % and less than or equal to 79 mol %, or any and all sub-ranges formed form any of these endpoints.

Like SiO₂, Al₂O₃ may also stabilize the glass network and additionally provides improved mechanical properties and chemical durability to the glass-ceramic articles. The amount of Al₂O₃ may also be tailored to the control the viscosity of the glass composition. However, if the amount of Al₂O₃ is too high, the viscosity of the melt may increase. In embodiments, the glass composition and the resultant glass-ceramic article may comprise greater than or equal to 7 mol % and less than or equal to 20 mol % Al₂O₃. In embodiments, the concentration of Al₂O₃ in the glass composition and the resultant glass-ceramic article may be greater than or equal to 7 mol %, greater than or equal to 8 mol %, greater than or equal to 9 mol %, greater than or equal to 10 mol %, or even greater than or equal to 11 mol %. In embodiments, the concentration of Al₂O₃ in the glass composition and the resultant glass-ceramic article may be less than or equal to 20 mol %, less than or equal to 18 mol %, less than or equal to 16 mol %, or even less than or equal to 14 mol %. In embodiments, the concentration of Al₂O₃ in the glass composition and the resultant glass-ceramic article may be greater than or equal to 7 mol % and less than or equal to 20 mol %, greater than or equal to 7 mol % and less than or equal to 18 mol %, greater than or equal to 7 mol % and less than or equal to 16 mol %, greater than or equal to 7 mol % and less than or equal to 14 mol %, greater than or equal to 8 mol % and less than or equal to 20 mol %, greater than or equal to 8 mol % and less than or equal to 18 mol %, greater than or equal to 8 mol % and less than or equal to 16 mol %, greater than or equal to 8 mol % and less than or equal to 14 mol %, greater than or equal to 9 mol % and less than or equal to 20 mol %, greater than or equal to 9 mol % and less than or equal to 18 mol %, greater than or equal to 9 mol % and less than or equal to 16 mol %, greater than or equal to 9 mol % and less than or equal to 14 mol %, greater than or equal to 10 mol % and less than or equal to 20 mol %, greater than or equal to 10 mol % and less than or equal to 18 mol %, greater than or equal to 10 mol % and less than or equal to 16 mol %, greater than or equal to 10 mol % and less than or equal to 14 mol %, greater than or equal to 11 mol % and less than or equal to 20 mol %, greater than or equal to 11 mol % and less than or equal to 18 mol %, greater than or equal to 11 mol % and less than or equal to 16 mol %, or even greater than or equal to 11 mol % and less than or equal to 14 mol %, or any and all sub-ranges formed from any of these endpoints.

ZnO in the glass compositions and the resultant glass-ceramic article may aid in charge balancing the Al₂O₃ in the glass composition, either by itself or in conjunction with Li₂O. Charge balancing the Al₂O₃ aids in achieving the desired stuffed α-quartz crystalline phase in the glass-ceramic article, as will be described in further detail herein. Upon heating the glass composition, Zn may enter the crystalline phase to form a stuffed β-quartz phase. Upon cooling, the β-quartz phase becomes partially de-stuffed with the exsolved ZnO and Al₂O₃ components combining to form gahnite (i.e., ZnAl₂O₄). In embodiments, the glass composition and the resultant glass-ceramic article may comprise greater than or equal to 4.5 mol % and less than or equal to 12 mol % ZnO. In embodiments, the glass composition and the resultant glass-ceramic article may comprise greater than or equal to 5 mol % and less than or equal to 11 mol % ZnO. In embodiments, the concentration of ZnO in the glass composition and the resultant glass-ceramic article may be greater than or equal to 4.5 mol %, greater than or equal to 5 mol %, greater than or equal to 5.5 mol %, or even greater than or equal to 6 mol %. In embodiments, the concentration of ZnO in the glass composition and the resultant glass-ceramic article may be less than or equal to 12 mol %, less than or equal to 11 mol %, less than or equal to 10 mol %, or even less than or equal to 9 mol %. In embodiments, the concentration of ZnO in the glass composition and the resultant glass-ceramic article may be greater than or equal to 4.5 mol % and less than or equal to 12 mol %, greater than or equal to 4.5 mol % and less than or equal to 11 mol %, greater than or equal to 4.5 mol % and less than or equal to 10 mol %, greater than or equal to 4.5 mol % and less than or equal to 9 mol %, greater than or equal to 5 mol % and less than or equal to 12 mol %, greater than or equal to 5 mol % and less than or equal to 11 mol %, greater than or equal to 5 mol % and less than or equal to 10 mol %, greater than or equal to 5 mol % and less than or equal to 9 mol %, greater than or equal to 5.5 mol % and less than or equal to 12 mol %, greater than or equal to 5.5 mol % and less than or equal to 11 mol %, greater than or equal to 5.5 mol % and less than or equal to 10 mol %, greater than or equal to 5.5 mol % and less than or equal to 9 mol %, greater than or equal to 6 mol % and less than or equal to 12 mol %, greater than or equal to 6 mol % and less than or equal to 11 mol %, greater than or equal to 6 mol % and less than or equal to 10 mol %, or even greater than or equal to 6 mol % and less than or equal to 9 mol %, or any and all sub-ranges formed from any of these endpoints.

Li₂O aids in forming the crystalline phase. Li₂O, in conjunction with ZnO, may aid in charge balancing the Al₂O₃ in the crystalline quartz phase. Upon heating the glass composition, Li₂O, and Zn may enter the crystalline phase of the glass-ceramic to form a stuffed β-quartz phase. The resulting quartz phase upon cooling, still partially stuffed with Li, now includes a high enough concentration of SiO₂ to invert on cooling to ambient temperature to stuffed α-quartz. The Li-stuffed α-quartz results in a relatively high hardness glass-ceramic article as compared to a β-quartz glass-ceramic article. In addition, it has been found that Li₂O has a pronounced effect on reducing the melting point, softening point, and molding temperature of the glass composition and, as such, LizO is effective at offsetting the reduction in formability of the glass composition and the resultant glass-ceramic article composition due to the inclusion of, for example and without limitation, higher concentrations of SiO₂. LizO also enables the ion-exchangeability of the glass-ceramic article.

In embodiments, the glass composition and the resultant glass-ceramic article may comprise greater than or equal to 1 mol % and less than or equal to 8 mol % Li₂O. In embodiments, the glass composition and the resultant glass-ceramic article may comprise greater than or equal to 1.5 mol % and less than or equal to 7 mol % Li₂O. In embodiments, the concentration of Li₂O in the glass composition and the resultant glass-ceramic article may be greater than or equal to 1 mol %, greater than or equal to 1.5 mol %, greater than or equal to 2 mol %, greater than or equal to 2.5 mol %, or even greater than or equal to 3 mol %. In embodiments, the concentration of Li₂O in the glass composition and the resultant glass-ceramic article may be less than or equal to 8 mol %, less than or equal to 7 mol %, less than or equal to 6 mol %, or even less than or equal to 5 mol %. In embodiments, the concentration of Li₂O in the glass composition and the resultant glass-ceramic article may be greater than or equal to 1 mol % and less than or equal to 8 mol %, greater than or equal to 1 mol % and less than or equal to 7 mol %, greater than or equal to 1 mol % and less than or equal to 6 mol %, greater than or equal to 1 mol % and less than or equal to 5 mol %, greater than or equal to 1.5 mol % and less than or equal to 8 mol %, greater than or equal to 1.5 mol % and less than or equal to 7 mol %, greater than or equal to 1.5 mol % and less than or equal to 6 mol %, greater than or equal to 1.5 mol % and less than or equal to 5 mol %, greater than or equal to 2 mol % and less than or equal to 8 mol %, greater than or equal to 2 mol % and less than or equal to 7 mol %, greater than or equal to 2 mol % and less than or equal to 6 mol %, greater than or equal to 2 mol % and less than or equal to 5 mol %, greater than or equal to 2.5 mol % and less than or equal to 8 mol %, greater than or equal to 2.5 mol % and less than or equal to 7 mol %, greater than or equal to 2.5 mol % and less than or equal to 6 mol %, greater than or equal to 2.5 mol % and less than or equal to 5 mol %, greater than or equal to 3 mol % and less than or equal to 8 mol %, greater than or equal to 3 mol % and less than or equal to 7 mol %, greater than or equal to 3 mol % and less than or equal to 6 mol %, or even greater than or equal to 3 mol % and less than or equal to 5 mol %, or any and all sub-ranges formed from any of these endpoints.

In embodiments, a ratio of Al₂O₃ to the sum of ZnO and Li₂O (i.e., Al₂O₃ (mol %)/(ZnO (mol %)+Li₂O (mol %)) in the glass composition may be greater than or equal to 1.00 and less than or equal to 1.45 to achieve the desired stuffed α-quartz crystalline phase in the resultant glass-ceramic article. As described herein, ZnO in conjunction with Li₂O may aid in charge balancing the Al₂O₃ in the glass composition. Charge balancing the Al₂O₃ aids in achieving the desired stuffed α-quartz crystalline phase in the glass-ceramic article. A ratio of Al₂O₃/(ZnO+Li₂O) near unity (e.g., greater than or equal to 1.00 and less than or equal to 1.45) is indicative of such charge balancing. In embodiments, Al₂O₃/(ZnO+Li₂O) in the glass composition may be greater than or equal to 1.10 and less than or equal to 1.35. In embodiments, Al₂O₃/(ZnO+Li₂O) in the glass composition may be greater than or equal to 1.00 or even greater than or equal to 1.10. In embodiments, Al₂O₃/(ZnO+Li₂O) in the glass composition may be less than or equal to 1.45, less than or equal to 1.35, or even less than or equal to 1.25. In embodiments, Al₂O₃/(ZnO+Li₂O) in the glass composition may be greater than or equal to 1.00 and less than or equal to 1.45, greater than or equal to 1.00 and less than or equal to 1.35, greater than or equal to 1.00 and less than or equal to 1.25, greater than or equal to 1.10 and less than or equal to 1.45, greater than or equal to 1.10 and less than or equal to 1.35, or even greater than or equal to 1.10 and less than or equal to 1.25, or any and all sub-ranges formed from any of these endpoints. In embodiments, Al₂O₃/(ZnO+Li₂O) in the resultant glass-ceramic article may be the same as or similar to Al₂O₃/(ZnO+Li₂O) in the glass composition from which the resultant glass-ceramic article is formed.

As noted herein, the glass compositions and the resultant glass-ceramic articles described herein further include ZrO₂. As a nucleating agent, ZrO₂ functions to produce bulk nucleation of the crystalline phase in the glass, thereby transforming the glass into a glass-ceramic. If the concentration of ZrO₂ is too low (e.g., less than 0.5 mol %), internal nucleation will not occur. However, if the concentration of ZrO₂ is too high (e.g., greater than 4 mol %), ZrO₂ may not be soluble in the glass composition, resulting in ZrO₂ stones. In embodiments, the glass composition and the resultant glass-ceramic article may comprise greater than or equal to 0.5 mol % and less than or equal to 4 mol % ZrO₂. In embodiments, the glass composition and the resultant glass-ceramic article may comprise greater than or equal to 1 mol % and less than or equal to 3.5 mol % ZrO₂. In embodiments, the concentration of ZrO₂ in the glass composition and the resultant glass-ceramic article may be greater than or equal to 0.5 mol %, greater than or equal to 0.75 mol %, greater than or equal to 1 mol %, or even greater than or equal to 1.25 mol %. In embodiments, the concentration of ZrO₂ in the glass composition and the resultant glass-ceramic article may be less than or equal to 4 mol %, less than or equal to 3.5 mol %, less than or equal to 3 mol %, less than or equal to 2.5 mol %, or even less than or equal to 2 mol %. In embodiments, the concentration of ZrO₂ in the glass composition and the resultant glass-ceramic article may be greater than or equal to 0.5 mol % and less than or equal to 4 mol %, greater than or equal to 0.5 mol % and less than or equal to 3.5 mol %, greater than or equal to 0.5 mol % and less than or equal to 3 mol %, greater than or equal to 0.5 mol % and less than or equal to 2.5 mol %, greater than or equal to 0.5 mol % and less than or equal to 2 mol %, greater than or equal to 0.75 mol % and less than or equal to 4 mol %, greater than or equal to 0.75 mol % and less than or equal to 3.5 mol %, greater than or equal to 0.75 mol % and less than or equal to 3 mol %, greater than or equal to 0.75 mol % and less than or equal to 2.5 mol %, greater than or equal to 0.75 mol % and less than or equal to 2 mol %, greater than or equal to 1 mol % and less than or equal to 4 mol %, greater than or equal to 1 mol % and less than or equal to 3.5 mol %, greater than or equal to 1 mol % and less than or equal to 3 mol %, greater than or equal to 1 mol % and less than or equal to 2.5 mol %, greater than or equal to 1 mol % and less than or equal to 2 mol %, greater than or equal to 1.25 mol % and less than or equal to 4 mol %, greater than or equal to 1.25 mol % and less than or equal to 3.5 mol %, greater than or equal to 1.25 mol % and less than or equal to 3 mol %, greater than or equal to 1.25 mol % and less than or equal to 2.5 mol %, or even greater than or equal to 1.25 mol % and less than or equal to 2 mol %, or any and all sub-ranges formed from any of these endpoints.

In embodiments, in addition to ZrO₂, the glass compositions and the resultant glass-ceramic articles may further include other nucleating agents, such as TiO₂, SnO₂, HfO₂, or combinations thereof.

In embodiments, the glass compositions and the resultant glass-ceramic articles herein may further include MgO.

In embodiments, the glass compositions and the resultant glass-ceramic articles described herein may further include one or more fining agents. In embodiments, the fining agents may include, for example, SnO₂. In embodiments, the glass composition and the resultant glass-ceramic article may comprise greater than 0 mol % and less than or equal to 1 mol % SnO₂. In embodiments, the concentration of SnO₂ in the glass compositions and the resultant glass-ceramic article may be greater than or equal to 0 mol % or even greater than or equal to 0.05 mol %. In embodiments, the concentration of SnO₂ in the glass compositions and the resultant glass-ceramic article may be less than or equal to 1 mol %, less than or equal to 0.75 mol %, less than or equal to 0.5 mol %, or even less than or equal to 0.25 mol %. In embodiments, the concentration of SnO₂ in the glass compositions and the resultant glass-ceramic article may be greater than 0 mol % and less than or equal to 1 mol %, greater than 0 mol % and less than or equal to 0.75 mol %, greater than 0 mol % and less than or equal to 0.5 mol %, greater than 0 mol % and less than or equal to 0.25 mol %, greater than 0.05 mol % and less than or equal to 1 mol %, greater than 0.05 mol % and less than or equal to 0.75 mol %, greater than 0.05 mol % and less than or equal to 0.5 mol %, or even greater than 0.05 mol % and less than or equal to 0.25 mol %, or any and all sub-ranges formed from any of these endpoints. In embodiments, the glass composition or the resultant glass-ceramic article may be free or substantially free of SnO₂.

In embodiments, the glass composition and the resultant glass-ceramic article described herein may further include tramp materials such as TiO₂, MnO, MoO₃, WO₃, Y₂O₃, La₂O₃, CdO, As₂O₃, Sb₂O₃, sulfur-based compounds, such as sulfates, halogens, or combinations thereof. In embodiments, antimicrobial components, chemical fining agents, or other additional components may be included in the glass composition and the resultant glass-ceramic article.

The glass-ceramic articles formed from the glass composition or precursor glass articles described herein may be any suitable thickness, which may vary depending on the particular application for use of the glass-ceramic. Glass-ceramic sheet embodiments may have a thickness from 0.4 mm to 10 mm. In embodiments, the glass-ceramic sheet embodiments may have a thickness of 6 mm or less, 5 mm or less, 4 mm or less, 3 mm or less, 2 mm or less, 1.0 mm or less, 750 μm or less, 500 μm or less, or 250 μm or less. In embodiments, the glass-ceramic sheet embodiments may have a thickness from 200 μm to 5 mm, from 500 μm to 5 mm, from 200 μm to 4 mm, from 200 μm to 2 mm, from 400 μm to 5 mm, or from 400 μm to 2 mm. In embodiments, the glass-ceramic sheet embodiments may have a thickness from 3 mm to 6 mm or from 0.8 mm to 3 mm. It should be understood that the thickness of the article may be within a sub-range formed from any and all of the foregoing endpoints.

As mentioned herein, α-quartz and gahnite in the glass-ceramic article results in a relatively high hardness glass-ceramic article as compared to a β-quartz glass-ceramic article. In embodiments, a total amount of stuffed α-quartz in the crystalline phase may be greater than or equal to 60 wt %, based on a total weight of the crystalline phase. In embodiments, a total amount of stuffed α-quartz in the crystalline phase may be greater than or equal to 60 wt %, greater than or equal to 65 wt %, greater than or equal to 70 wt %, or even greater than or equal to 75 wt %, based on a total weight of the crystalline phase. In embodiments, a total amount of stuffed α-quartz in the crystalline phase may be less than or equal to 90 wt %, less than or equal to 85 wt %, or even less than or equal to 80 wt %, based on a total weight of the crystalline phase. In embodiments, a total amount of stuffed α-quartz in the crystalline phase may be greater than or equal to 60 wt % and less than or equal to 90 wt %, greater than or equal to 60 wt % and less than or equal to 85 wt %, greater than or equal to 60 wt % and less than or equal to 80 wt %, greater than or equal to 65 wt % and less than or equal to 90 wt %, greater than or equal to 65 wt % and less than or equal to 85 wt %, greater than or equal to 65 wt % and less than or equal to 80 wt %, greater than or equal to 70 wt % and less than or equal to 90 wt %, greater than or equal to 70 wt % and less than or equal to 85 wt %, greater than or equal to 70 wt % and less than or equal to 80 wt %, greater than or equal to 75 wt % and less than or equal to 90 wt %, greater than or equal to 75 wt % and less than or equal to 85 wt %, or even greater than or equal to 75 wt % and less than or equal to 80 wt %, or any and all sub-ranges formed from any of these endpoints.

In embodiments, a total amount of gahnite in the crystalline phase may be less than or equal to 30 wt %, less than or equal to 25 wt %, less than or equal to 20 wt %, or even less than or equal to 15 wt %, based on a total weight of the crystalline phase. In embodiments, a total amount of gahnite in the crystalline phase may be greater 0 wt %, greater than or equal to 5 wt %, or even greater than or equal to 10 wt %, based on a total weight of the crystalline phase. In embodiments, a total amount of gahnite in the crystalline phase may be greater than 0 wt % and less than or 30 wt %, greater than 0 wt % and less than or 25 wt %, greater than 0 wt % and less than or 20 wt %, greater than 0 wt % and less than or 15 wt %, greater than or equal to 5 wt % and less than or equal to 30 wt %, greater than or equal to 5 wt % and less than or equal to 25 wt %, greater than or equal to 5 wt % and less than or equal to 20 wt %, greater than or equal to 5 wt % and less than or equal to 15 wt %, greater than or equal to 10 wt % and less than or equal to 30 wt %, greater than or equal to 10 wt % and less than or equal to 25 wt %, greater than or equal to 10 wt % and less than or equal to 20 wt %, or even greater than or equal to 10 wt % and less than or equal to 15 wt %, or any and all sub-ranges formed from any of these endpoints.

In embodiments, the crystalline phase may further comprise β-quartz, zirconia, mullite, or a combination thereof.

The amount of the crystalline phase and the residual glass phase by weight of the glass-ceramic article is determined according to Rietveld analysis of the XRD spectrum of the glass-ceramic article. In embodiments, the glass-ceramic article may include greater than or equal to 50 wt %, greater than or equal to 60 wt %, greater than or equal to 70 wt %, or even greater than or equal to 75 wt % of the crystalline phase by weight of the glass-ceramic article. In embodiments, the glass-ceramic article may include less than or equal to 96 wt %, less than or equal to 90 wt %, or even less than or equal to 85 wt % of the crystalline phase by weight of the glass-ceramic article. In embodiments, the glass-ceramic article may include greater than or equal to 50 wt % and less than or equal to 96 wt %, greater than or equal to 50 wt % and less than or equal to 90 wt %, greater than or equal to 50 wt % and less than or equal to 85 wt %, greater than or equal to 60 wt % and less than or equal to 96 wt %, greater than or equal to 60 wt % and less than or equal to 90 wt %, greater than or equal to 60 wt % and less than or equal to 85 wt %, greater than or equal to 70 wt % and less than or equal to 96 wt %, greater than or equal to 70 wt % and less than or equal to 90 wt %, greater than or equal to 70 wt % and less than or equal to 85 wt %, greater than or equal to 80 wt % and less than or equal to 96 wt %, greater than or equal to 80 wt % and less than or equal to 90 wt %, or even greater than or equal to 80 wt % and less than or equal to 85 wt %, or any and all sub-ranges formed from any of these endpoints, of the crystalline phase by weight of the glass-ceramic article.

In embodiments, the glass-ceramic article may include less than or equal to 50 wt %, less than or equal to 40 wt %, less than or equal to 30 wt %, or even less than or equal to 20 wt % of the residual glass phase by weight of the glass-ceramic article. In embodiments, the glass-ceramic article may include greater or equal to 4 wt %, greater than or equal to 10 wt %, or even greater than or equal to 15 wt % of the residual glass phase by weight of the glass-ceramic article. In embodiments, the glass-ceramic article may include greater than or equal to 4 wt % and less than or equal to 50 wt %, greater than or equal to 4 wt % and less than or equal to 40 wt %, greater than or equal to 4 wt % and less than or equal to 30 wt %, greater than or equal to 4 wt % and less than or equal to 20 wt %, greater than or equal to 10 wt % and less than or equal to 50 wt %, greater than or equal to 10 wt % and less than or equal to 40 wt %, greater than or equal to 10 wt % and less than or equal to 30 wt %, greater than or equal to 10 wt % and less than or equal to 20 wt %, greater than or equal to 15 wt % and less than or equal to 50 wt %, greater than or equal to 15 wt % and less than or equal to 40 wt %, greater than or equal to 15 wt % and less than or equal to 30 wt %, or even greater than or equal to 15 wt % and less than or equal to 20 wt %, or any and all sub-ranges formed from any of these endpoints, of the residual glass phase by weight of the glass-ceramic article.

In embodiments, the glass-ceramic article may be opaque, translucent, transparent haze, or transparent. In embodiments, the glass-ceramic article may have an average transmittance greater than or equal to 0% and less than 20% over the wavelength range of 400 nm to 800 nm as measured at an article thickness of 0.8 mm. In embodiments, the glass-ceramic article may have an average transmittance greater than or equal to 20% over the wavelength range of 400 nm to 800 nm as measured at an article thickness of 0.8 mm. In embodiments, the glass-ceramic article may have an average transmittance greater than or equal to 50% over the wavelength range of 400 nm to 800 nm as measured at an article thickness of 0.8 mm. In embodiments, the glass-ceramic article may have an average transmittance greater than or equal to 85% over the wavelength range of 400 nm to 800 nm as measured at an article thickness of 0.8 mm.

In embodiments, the glass-ceramic article may have Mohs hardness greater than or greater than or equal to 7.

In embodiments, the glass-ceramic article may have a Vickers hardness greater than 800 kgf/mm, greater than or equal to 825 kgf/mm, greater than or equal to 850 kg/mm, or even greater than or equal to 875 kg/mm. In embodiments, the glass-ceramic article may have a Vickers hardness less than or equal to 1000 kg/mm or even less than or equal to 950 kg/mm. In embodiments, the glass-ceramic article may have a Vickers hardness greater than or equal to 800 kg/mm and less than or equal to 1000 kg/mm, greater than or equal to 800 kg/mm and less than or equal to 950 kg/mm, greater than or equal to 825 kg/mm and less than or equal to 1000 kg/mm, greater than or equal to 825 kg/mm and less than or equal to 950 kg/mm, greater than or equal to 850 kg/mm and less than or equal to 1000 kg/mm, greater than or equal to 850 kg/mm and less than or equal to 950 kg/mm, greater than or equal to 875 kg/mm and less than or equal to 1000 kg/mm, or even greater than or equal to 875 kg/mm and less than or equal to 950 kg/mm, or any and all sub-ranges formed from any of these endpoints.

In embodiments, the glass-ceramic article may have a Young's modulus greater than or equal to 70 GPa or even greater than or equal to 80 GPa. In embodiments, the glass-ceramic article may have a Young's modulus less than or equal to 110 GPa or even less than or equal to 100 GPa. In embodiments, the glass-ceramic article may have a Young's modulus greater than or equal to 70 GPa and less than or equal to 110 GPa, greater than or equal to 70 GPa and less than or equal to 100 GPa, greater than or equal to 80 GPa and less than or equal to 110 GPa, or even greater than or equal to 80 GPa and less than or equal to 100 GPa, or any and all sub-ranges formed from any of these endpoints.

In embodiments, the glass-ceramic article may have a Shear modulus greater than or equal to 35 GPa or even greater than or equal to 40 GPa. In embodiments, the glass-ceramic article may have a Shear modulus less than or equal to 50 GPa or even less than or equal to 45 GPa. In embodiments, the glass-ceramic article may have a shear modulus greater than or equal to 35 GPa and less than or equal to 50 GPa, greater than or equal to 35 GPa and less than or equal to 45 GPa, greater than or equal to 40 GPa and less than or equal to 50 GPa, or even greater than or equal to 40 GPa and less than or equal to 45 GPa, or any and all sub-ranges formed from any of these endpoints.

In embodiments, the glass-ceramic article may have a Poisson's ratio greater than or equal to 0.080 or even greater than or equal to 0.085. In embodiments, the glass-ceramic article may have a Poisson's ratio less than or equal to 0.115 or even less than or equal to 0.110. In embodiments, the glass-ceramic article may have a Poisson's ratio greater than or equal to 0.080 and less than or equal to 0.115, greater than or equal to 0.080 and less than or equal to 0.110, greater than or equal to 0.085 and less than or equal to 0.115, or even greater than or equal to 0.085 and less than or equal to 0.110, or any and all sub-ranges formed from any of these endpoints.

In embodiments, the glass-ceramic article may have a fracture toughness (K_{IC}) greater than or equal to 0.8 MPa·m^{1/2} or even greater than or equal to 0.8 MPa·m^{1/2} .

In embodiments, the glass-ceramic article may have a coefficient of thermal expansion (CTE), greater than or equal to 100×10⁻⁷/° C. and less than or equal to 300×10⁻⁷/° C., greater than or equal to 125×10⁻⁷/° C. and less than or equal to 250×10⁻⁷/° C., or even greater than or equal to 150×10⁻⁷/° C. and less than or equal to 225×10⁻⁷/° C., or any and all subranges formed from any of these endpoints, as measured over a temperature range of 25° C. to 300° C.

In embodiments, the glass-ceramic article may have a coefficient of thermal expansion (CTE), greater than or equal to 3×10⁻⁷/° C. and less than or equal to 50×10⁻⁷/° C., greater than or equal to 5×10⁻⁷/° C. and less than or equal to 40×10⁻⁷/° C., or even greater than or equal to 10×10⁻⁷/° C. and less than or equal to 30×10⁻⁷/° C., or any and all subranges formed from any of these endpoints, as measured over a temperature range of 300° C. to 600° C.

In embodiments, the glass-ceramic articles described herein are ion exchangeable to facilitate strengthening the glass-ceramic article. In typical ion exchange processes, smaller metal ions in the glass-ceramic article are replaced or “exchanged” with larger metal ions of the same valence within a layer that is close to the outer surface of the glass-ceramic. The replacement of smaller ions with larger ions creates a compressive stress within the layer of the glass-ceramic article. In embodiments, the metal ions are monovalent metal ions (e.g., Li⁺, Na⁺, K⁺, and the like), and ion exchange is accomplished by immersing the glass-ceramic in a bath comprising at least one molten salt of the larger metal ion that is to replace the smaller metal ion in the glass-ceramic. Alternatively, other monovalent ions such as Ag⁺, Tl⁺, Cu⁺, and the like may be exchanged for monovalent ions. The ion exchange process or processes that are used to strengthen the glass-ceramic article may include, but are not limited to, immersion in a single bath or multiple baths of like or different compositions with washing and/or annealing steps between immersions.

Upon exposure to the glass-ceramic article, the ion-exchange solution (e.g., KNO₃ and/or NaNO₃ molten salt bath) may, according to embodiments, be at a temperature greater than or equal to 350° C. and less than or equal to 550° C., greater than or equal to 350° C. and less than or equal to 525° C., greater than or equal to 350° C. and less than or equal to 500° C., greater than or equal to 350° C. and less than or equal to 475° C., greater than or equal to 375° C. and less than or equal to 550° C., greater than or equal to 375° C. and less than or equal to 525° C., greater than or equal to 375° C. and less than or equal to 500° C., greater than or equal to 375° C. and less than or equal to 475° C., greater than or equal to 400° C. and less than or equal to 550° C., greater than or equal to 400° C. and less than or equal to 525° C., greater than or equal to 400° C. and less than or equal to 500° C., or even greater than or equal to 400° C. and less than or equal to 475° C., or any and all sub-ranges formed from any of these endpoints. In embodiments, the glass-ceramic article may be exposed to the ion-exchange solution for a duration greater than or equal to 2 hours and less than or equal to 12 hours, greater than or equal to 2 hours and less than or equal to 10 hours, greater than or equal to 2 hours and less than or equal to 8 hours, greater than or equal to 4 hours and less than or equal to 12 hours, greater than or equal to 4 hours and less than or equal to 10 hours, or even greater than or equal to 4 hours and less than or equal to 8 hours, or any and all sub-ranges formed from any of these endpoints.

In embodiments, the glass-ceramic article may comprise a peak surface compressive stress, after ion exchange strengthening, greater than or equal to 80 MPa and less than or equal to 200 MPa.

In embodiments, the glass-ceramic article may comprise a depth of compression, after ion exchange strengthening, greater than or equal to 10 μm, greater than or equal to 20 μm, greater than or equal to 30 μm, greater than or equal to 40 μm, or even greater than or equal to 50 μm. In embodiments, the glass-ceramic article has a thickness “t” and may have a depth of compression, after ion exchange strengthening greater than or equal to 0.05 t, greater than or equal to 0.1 t, greater than or equal to 0.15 t, greater than or equal to 0.2 t, or even greater than or equal to 0.25 t.

In embodiments, the glass-ceramic article may comprise a maximum central tension, after ion exchange strengthening, greater than or equal to 10 MPa and less than or equal to 100, as measured at an article thickness of 0.8 mm.

In embodiments, the processes for making the glass-ceramic article includes heat treating the glass composition at one or more preselected temperatures for one or more preselected times to induce crystallization (i.e., nucleation and growth) of one or more crystalline phases (e.g., having one or more compositions, amounts, morphologies, sizes or size distributions, etc.). In embodiments, the heat treatment may include (i) heating a precursor glass article in an oven at a rate of greater than or equal to 1° C./min and less than or equal to 10° C./min to a nucleation temperature, wherein the precursor glass article comprises a glass composition as described herein; (ii) maintaining the precursor glass article at the nucleation temperature for a time in the range from between 0.1 hour to 8 hours to produce a nucleated crystallizable glass article; (iii) heating the nucleated crystallizable glass article at a rate greater than or equal to 1° C./min and less than or equal to 10° C./min to a crystallization temperature (Tc); (iv) maintaining the nucleated crystallizable glass article at the crystallization temperature for a time greater than or equal to 0.25 hour and less than or equal to 4 hours to produce the glass-ceramic article described herein; and (v) cooling the formed glass-ceramic article to room temperature.

In embodiments, the nucleation temperature may be greater than or equal to 750° C. and less than or equal to 900° C. As used herein, the term “crystallization temperature” may be used interchangeably with “ceram temperature” or “ceramming temperature.” As described herein, the glass compositions are heated to a relatively high temperature phase such that stuffed β-quartz phase is produced. In embodiments, the crystallization temperature may be greater than or equal to 950° C. In embodiments, the crystallization temperature may be greater than or equal to 950° C. or even greater than or equal to 1050° C.

Temperature-temporal profiles of heat treatment steps of heating to the crystallization temperature and maintaining the temperature at the crystallization temperature in addition to glass compositions are judiciously prescribed so as to produce one or more of the following desired attributes: crystalline phase(s) of the glass-ceramic, proportions of one or more major crystalline phases and/or one or more minor crystalline phases and glass, crystal phase assemblages of one or more predominate crystalline phases and/or one or more minor crystalline phases and glass, and grain sizes or grain size distribution among one or more major crystalline phases and/or one or more minor crystalline phases, which in turn may influence the final integrity, quality, color, and/or opacity of the resultant glass-ceramic.

The glass-ceramics articles described herein may be used for a variety of applications including, for example, for cover glass or glass backplane applications in consumer or commercial electronic devices including, for example, LCD and LED displays, computer monitors, and automated teller machines (ATMs); for touch screen or touch sensor applications, for portable electronic devices including, for example, mobile telephones, personal media players, and tablet computers; for integrated circuit applications including, for example, semiconductor wafers; for photovoltaic applications; for architectural glass applications; for automotive or vehicular glass applications; or for commercial or household appliance applications. In embodiments, a consumer electronic device (e.g., smartphones, tablet computers, personal computers, ultrabooks, televisions, and cameras), an architectural glass, and/or an automotive glass may comprise a glass-ceramic article as described herein.

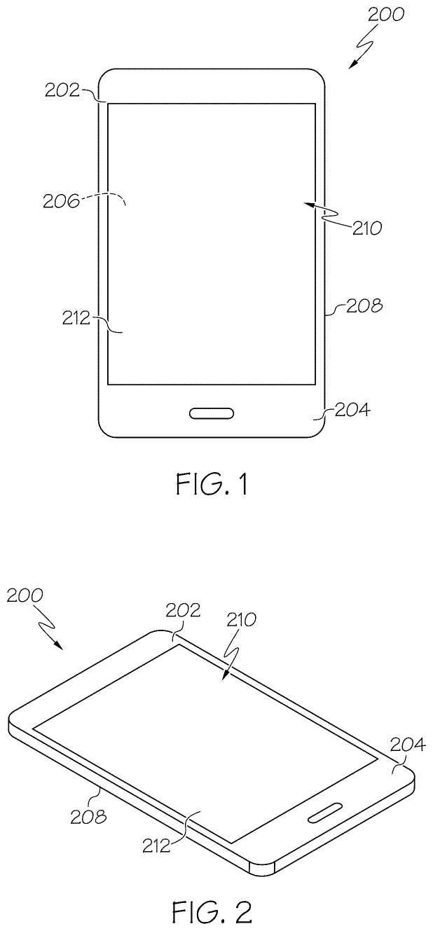

An exemplary electronic device incorporating any of the glass-ceramic articles disclosed herein is shown in FIGS. 1 and 1. Specifically, FIGS. 1 and 2 show a consumer electronic device 200 including a housing 202 having front 204, back 206, and side surfaces 108; electrical components (not shown) that are at least partially inside or entirely within the housing and including at least a controller, a memory, and a display 210 at or adjacent to the front surface of the housing; and a cover substrate 212 at or over the front surface of the housing such that it is over the display. In embodiments, at least a portion of at least one of the cover substrate 212 and the housing 202 may include any of the glass-ceramic articles disclosed herein.

### EXAMPLES

In order that various embodiments be more readily understood, reference is made to the following examples, which are intended to illustrate various embodiments of the glass-ceramic articles described herein.

Table 1 shows example glass compositions C1-C6 (in terms of mol %). Table 2 shows the heat treatment schedule for achieving example glass-ceramic articles A1-A6, and the respective properties of the glass-ceramic articles. Glass-ceramic articles A1-A6 were formed having the example glass compositions C1-C6 listed in Table 1.

TABLE 1

| Example | C1 | C2 | C3 | C4 | C5 | C6 |
|---|---|---|---|---|---|---|
| SiO₂ | 77.60 | 71.57 | 70.17 | 76.13 | 76.82 | 73.53 |
| Al₂O₃ | 10.81 | 14.12 | 15.51 | 12.28 | 11.49 | 13.24 |
| ZnO | 6.43 | 8.04 | 8.05 | 5.89 | 6.48 | 7.35 |
| Li₂O | 3.39 | 4.41 | 4.42 | 3.93 | 3.44 | 3.92 |
| ZrO₂ | 1.67 | 1.76 | 1.77 | 1.67 | 1.67 | 1.86 |
| SnO₂ | 0.10 | 0.10 | 0.10 | 0.10 | 0.10 | 0.10 |
| Al₂O₃/ | 1.10 | 1.13 | 1.24 | 1.25 | 1.16 | 1.17 |
| (ZnO + Li₂O) | | | | | | |

TABLE 2

| Example | A1 | A2 | A3 | A4 | A5 | A6 |
|---|---|---|---|---|---|---|
| Glass composition | C1 | C2 | C3 | C4 | C5 | C6 |
| Nucleation hold | 800° C. for | 800° C. for | 800° C. for | 800° C. for | 800° C. for | 800° C. for |
| | 4 hr | 4 hr | 4 hr | 4 hr | 4 hr | 4 hr |
| Crystallization hold | 1050° C. for | 1050° C. for | 1050° C. for | 1015° C. for | 1050° C. for | 1015° C. for |
| | 4 hr | 4 hr | 4 hr | 4 hr | 4 hr | 6 hr |
| Appearance | Translucent | Translucent | Transparent | Transparent | Transparent | Transparent |
| | | | haze | | | |
| Major crystalline phase | α-quartz | α-quartz | α-quartz, | stuffed | stuffed | stuffed |
| | | | β-quartz | α-quartz | α-quartz | α-quartz |
| Minor crystalline phase | gahnite, | gahnite, | gahnite, | gahnite, | gahnite, | gahnite, |
| | zirconia | zirconia | mullite, | zirconia | zirconia | zirconia |
| | | | zirconia | | | |
| Hardness (MOH) | — | — | — | 7.5 | — | — |
| Hardness (Vickers | 899 | — | — | — | — | 895 |
| (kgf/mm)) | | | | | | |
| Young's modulus (GPa) | 97 | — | — | 82 | — | 96 |
| Shear modulus (GPa) | 43.5 | — | — | 42.4 | — | 44.0 |
| Poisson's ratio | 0.104 | — | — | 0.098 | — | 0.106 |
| K_{Ic} (MPa · m^{1/2}) | — | — | — | 0.883 | — | — |

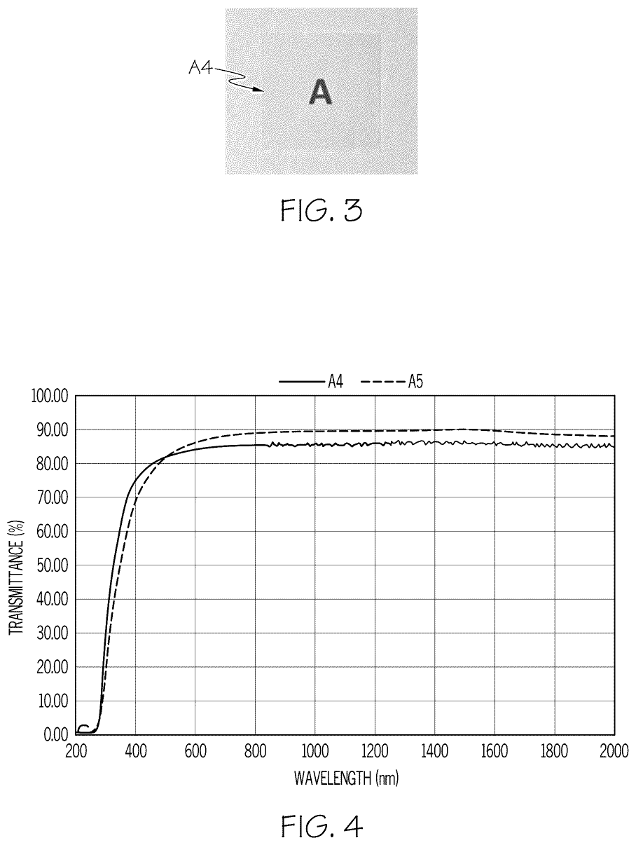

Referring now to FIG. 3, example glass-ceramic article A4 polished and having a thickness of 0.8 mm is shown with a transparent appearance. As indicated by FIG. 3, the glass compositions described herein may be subjected to certain heat treatments to achieve a transparent glass-ceramic article.

Referring now to FIG. 4, example glass-ceramic articles A4 and A5 having a thickness of 0.8 mm were ion exchanged in a 100% NaNO₃ molten salt bath at 450° C. for 2.25 hours. As shown, glass-ceramic articles A4 and A5 each had an average transmittance greater than 85% in a wavelength range from 400 nm to 800 nm. As indicated by FIG. 4, the glass-ceramic articles described herein may be ion exchanged to strengthen the glass-ceramic articles, while maintaining transparency.

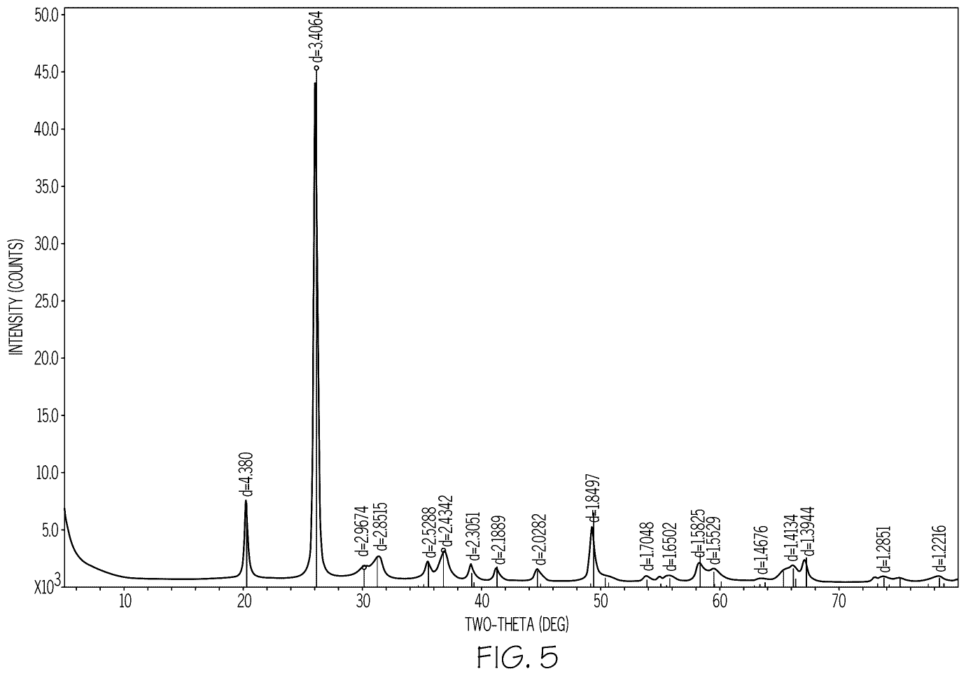

Referring now to FIG. 5, example-glass-ceramic article A4 had α-quartz present as a major crystalline phase and gahnite and zirconia present as a minor crystalline phase. The quartz peak at 2θ at 26° was shifted to higher d-spacings than pure-silica quartz, indicating the presence of SiO₂—LiAlO₂ solid solution (i.e., Li-stuffing). As indicated by FIG. 5, the glass compositions described herein may be subjected to certain heat treatments to achieve a glass-ceramic article with high crystallinity that includes a stuffed α-quartz as the predominant crystalline phase and gahnite as a minor crystalline phase.

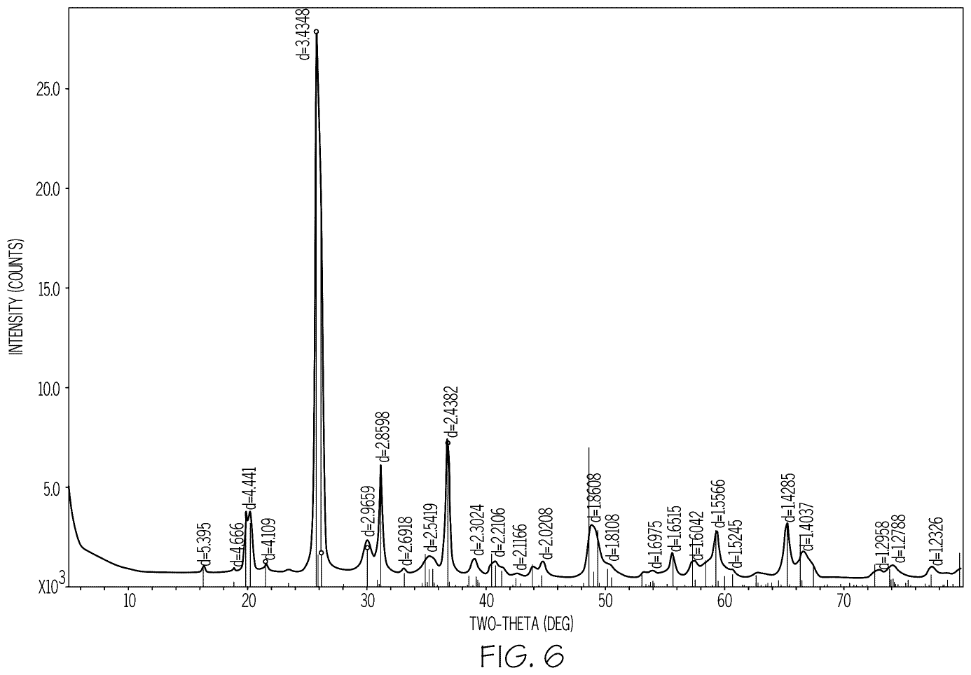

Referring now to FIG. 6, example glass-ceramic article A3 had α-quartz and β-quartz present as a major crystalline phase and gahnite, mullite, and zirconia present as a minor crystalline phase. The presence of the α-quartz and β-quartz was confirmed by the presence of doublet peaks in the quartz peak at 2θ at 20° and 26°. As indicated by FIG. 6, the glass compositions described herein may be subjected to certain heat treatments to achieve a glass-ceramic article including stuffed α-quartz, β-quartz, and gahnite.

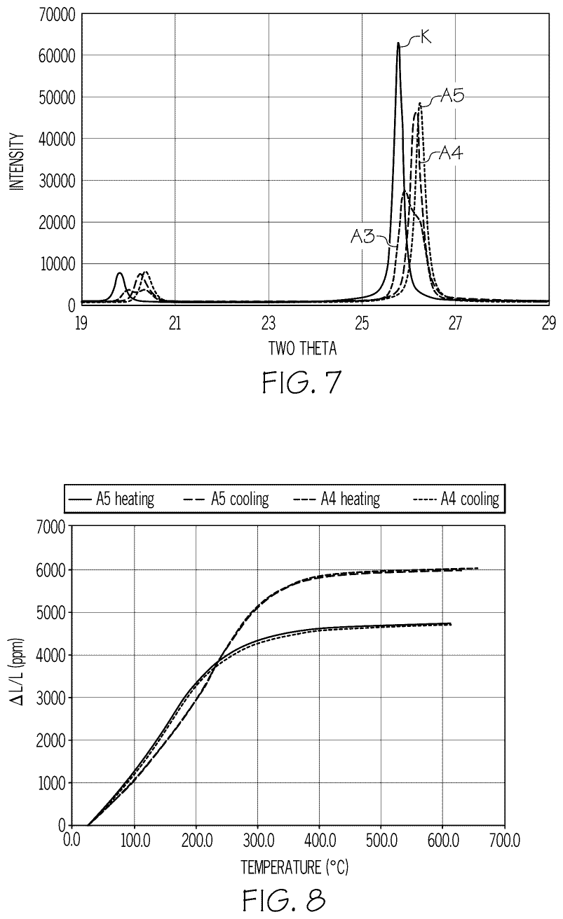

Referring now to FIG. 7, example glass-ceramic articles A3-A5 had higher 2θ angles and, thus, smaller d-spacings as compared to Li-stuffed β-quartz (i.e., virgilite) in KERALITE (Verotech Saint-Gobain International AG; “K” in the figure), indicating the presence of SiO₂—LiAlO₂ solid solution (i.e., Li-stuffing).

Referring now to FIG. 8, glass-ceramic articles A4 and A5 were heated at a rate of 4° C./min up to a maximum temperature of at least 600° C. as shown in FIG. 8, held at the maximum temperature for 5 minutes, and cooled at a rate of 4° C./min to room temperature. The transition of the glass-ceramic articles, at the hook, from lower expansion β-quartz to higher expansion α-quartz is shown in FIG. 8.

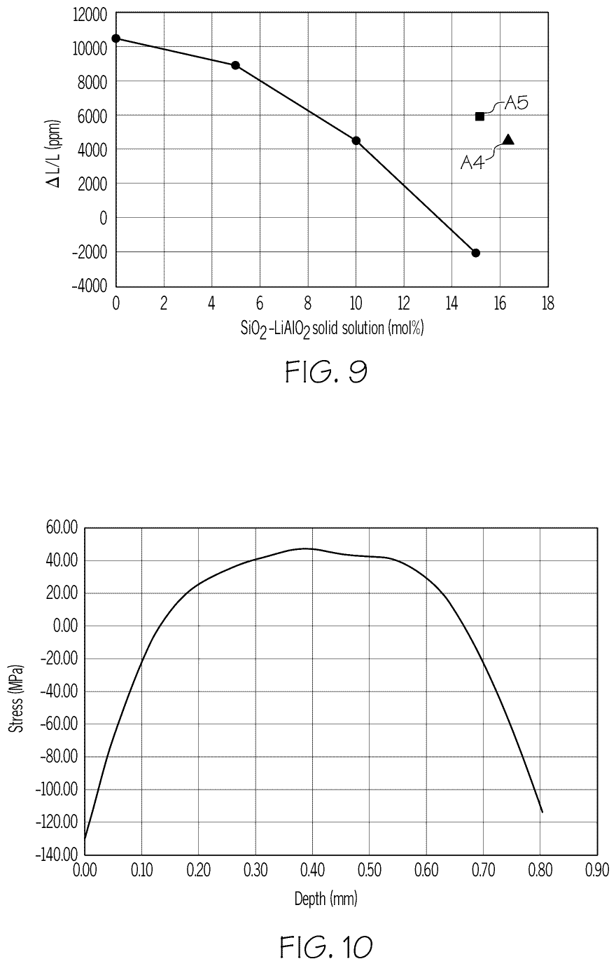

Referring now to FIG. 9, as the amount of SiO₂—LiAlO₂ solid solution (i.e., Li-stuffing) increases, the contraction decreases. The points on the curve were taken from Mainz Von Jürgen Petzoldt, “Metastable Mixed Crystals with Quartz Structure with Oxide System,” Proceedings at the 41^{st} Glass Technology Conference on May 9, 1967 in Lübeck (received Jun. 28, 1967). Note that example glass-ceramic articles A4 and A5 had data points outside the curve. While not wishing to be bound by theory, example glass-ceramic articles A4 and A5 may also have included SiO₂—ZnAl₂O₄ solid solution (i.e., Zn-stuffing), even after heating above 1000° C. where most is exsolved as gahnite (ZnAl₂O₄). The Zn-stuffing was not accounted for in FIG. 9.

Referring now to FIG. 10, glass-ceramic article A4 having a thickness of 0.8 mm was ion exchanged in a 100% NaNO₃ molten salt bath at 450° C. for 5 hours to achieve a parabolic stress profile as measured using SCALP. As indicated by FIG. 10, the glass-ceramic articles formed from the glass compositions and precursor glass articles described herein may be subjected to ion exchange to achieve a desired stress profile.

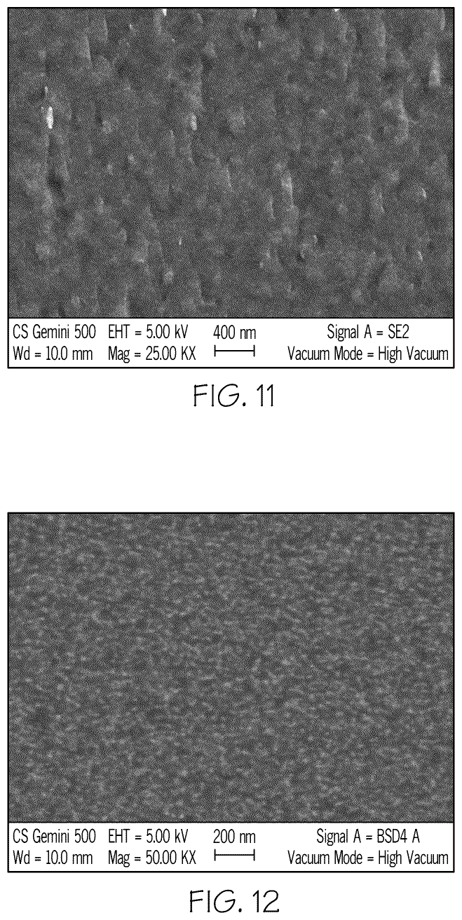

Referring now to FIGS. 11 and 12, example glass-ceramic article A2 had high crystallinity with pyramidal nanocrystals having triangular faces. As indicated by FIGS. 11 and 12, the glass compositions described herein may be subjected to a certain heat treatment to achieve a glass-ceramic article having high crystallinity including stuffed α-quartz and gahnite.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A glass-ceramic article comprising:
a crystalline phase comprising stuffed α-quartz and gahnite; and
a residual glass phase, the glass-ceramic article having a composition comprising:
greater than or equal to 69.5 mol % and less than or equal to 85 mol % SiO₂;
greater than or equal to 7 mol % and less than or equal to 20 mol % Al₂O₃;
greater than or equal to 4.5 mol % and less than or equal to 12 mol % ZnO;
greater than or equal to 1 mol % and less than or equal to 8 mol % Li₂O; and
greater than or equal to 0.5 mol % and less than or equal to 4 mol % ZrO₂.

2. The glass-ceramic article of claim 1, wherein a total amount of stuffed α-quartz is greater than or equal to 60 wt %, based on a total weight of the crystalline phase.

3. The glass-ceramic article of claim 1, wherein the glass-ceramic article comprises greater than or equal to 70 mol % and less than or equal to 83 mol % SiO₂.

4. The glass-ceramic article of claim 1, wherein the glass-ceramic article comprises greater than or equal to 5 mol % and less than or equal to 11 mol % ZnO.

5. The glass-ceramic article of claim 1, wherein the glass-ceramic article comprises greater than or equal to 1.5 mol % and less than or equal to 7 mol % Li₂O.

6. The glass-ceramic article of claim 1, wherein the glass-ceramic article comprises greater than or equal to 0.75 mol % and less than or equal to 3.5 mol % ZrO₂.

7. The glass-ceramic article of claim 1, wherein the glass-ceramic article comprises comprising greater than 0 mol % and less than or equal to 1 mol % SnO₂.

8. The glass-ceramic article of claim 1, wherein the crystalline phase further comprises B-quartz, zirconia, mullite, or a combination thereof.

9. The glass-ceramic article of claim 1, wherein a Mohs hardness of the glass-ceramic article is greater than or equal to 7.

10. The glass-ceramic article of claim 1, wherein the Vickers hardness of the glass-ceramic article may be greater than or equal to 800 kgf/mm.

11. The glass-ceramic article of claim 1, wherein a Poisson's ratio of the glass-ceramic article is greater than or equal to 0.085 and less than or equal to 0.11.

12. The glass-ceramic article of claim 1, wherein an average transmittance of the glass-ceramic article is greater than or equal to 20% over the wavelength range of 400 nm to 800 nm as measured at an article thickness of 0.8 mm.

13. A glass composition comprising:
greater than or equal to 69.5 mol % and less than or equal to 85 mol % SiO₂;
greater than or equal to 7 mol % and less than or equal to 20 mol % Al₂O₃;
greater than or equal to 4.5 mol % and less than or equal to 12 mol % ZnO;
greater than or equal to 1 mol % and less than or equal to 8 mol % Li₂O; and
greater than or equal to 0.5 mol % and less than or equal to 4 mol % ZrO₂,
wherein Al₂O₃/(ZnO+Li₂O) is greater than or equal to 1.00 and less than or equal to 1.45.

14. The glass composition of claim 13, wherein Al₂O₃/(ZnO+Li₂O) is greater than or equal to 1.10 and less than or equal to 1.35.

15. The glass composition of claim 13, wherein the glass composition comprises greater than or equal to 70 mol % and less than or equal to 83 mol % SiO₂.

16. A method of forming a glass-ceramic article, the method comprising:
heating a precursor glass article in an oven at a rate greater than or equal to 1° C./min and less than or equal to 10° C./min to a nucleation temperature, wherein the precursor glass article comprises a glass composition comprising:
greater than or equal to 67 mol % and less than or equal to 85 mol % SiO₂;
greater than or equal to 7 mol % and less than or equal to 20 mol % Al₂O₃;
greater than or equal to 4.5 mol % and less than or equal to 12 mol % ZnO;
greater than or equal to 1 mol % and less than or equal to 8 mol % Li₂O; and
greater than or equal to 0.5 mol % and less than or equal to 4 mol % ZrO₂,
wherein Al₂O₃/(ZnO+Li₂O) is greater than or equal to 1.00 and less than or equal to 1.45;
maintaining the precursor glass article at the nucleation temperature in the oven for time greater than or equal to 0.1 hour and less than or equal to 8 hours to produce a nucleated crystallizable glass article;
heating the nucleated crystallizable glass article in the oven at a rate greater than or equal to 1° C./min and less than or equal to 10° C./min to a crystallization temperature;
maintaining the nucleated crystallizable glass article at the crystallization temperature in the oven for a time greater than or equal to 0.25 hour and less than or equal to 4 hours to produce the glass-ceramic article, wherein the glass-ceramic article comprises a crystalline phase and a residual glass phase; and
cooling the glass-ceramic article to room temperature.

17. The method of claim 16, wherein the crystallization temperature is greater than or equal to 950° C.

18. The method of claim 16, wherein the crystalline phase comprises greater than or equal to 60 wt % stuffed α-quartz, based on a total weight of the crystalline phase.

19. The method of claim 16, further comprising strengthening the glass-ceramic article in an ion exchange bath at a temperature greater than or equal to 350° C. to less than or equal to 550° C. for a time period greater than or equal to 2 hours to less than or equal to 12 hours to form an ion exchanged glass-ceramic article.

20. The method of claim 19, wherein the glass-ceramic article comprises a peak surface compressive stress greater than or equal to 80 MPa, a depth of compression 10 μm or greater, a thickness “t,” and a depth of compression greater than or equal to 0.05 t.
